(19) United States
(12) Patent Application Publication
(10) Pub. No.: US 2026/0369041 A1
(43) Pub. Date: Nov. 19, 2026

(54) TRAINING DEVICE, TRAINING METHOD, AND STORAGE MEDIUM

(71) Applicant: NEC Corporation, Tokyo (JP)

(72) Inventor: Shigeaki NAMIKI, Tokyo (JP)

(73) Assignee: NEC Corporation, Tokyo (JP)

(21) Appl. No.: 19/477,275

(22) PCT Filed: May 29, 2023
(86) PCT No.: PCT/JP2023/019865

§ 371 Date: Oct. 21, 2025

(51) Int. Cl. G06V 10/774; G06T 7/00; G06V 10/25; G06V 10/74; G06V 10/77; G06V 10/776

(52) U.S. Cl. CPC G06V 10/774; G06T 7/0012; G06V 10/25; G06V 10/761; G06V 10/7715; G06V 10/776; G06T 2207/20081; G06T 2207/30096; G06V 2201/03

(57) ABSTRACT

A training device 1X mainly includes a feature amount acquisition means 33X and a training means 36X. The feature amount acquisition means 33X is configured to acquire a feature amount of an abnormal region of a training image that is an image used for training of an abnormality detection model and includes the abnormal region and a feature amount of an abnormality related region that is a region determined based on the abnormal region. The training means 36X is configured to train the abnormality detection model based on a degree of similarity between the feature amount of the abnormal region and the feature amount of the abnormality related region. It can be used for assisting user's decision making.

### TECHNICAL FIELD

The present disclosure relates to a technical field of a training device, a training method, and a storage medium related to training of a model that performs inference related to abnormality detection.

### BACKGROUND

Conventionally, a technology related to machine learning of an object detection model is known. For example, NPL 1 discloses Feature Pyramid Networks, which is an architecture of a neural network that performs inference by using a multiscale feature map. PTL 1 discloses a technology of detecting a candidate lesion region by using a machine learning model from a body cavity image obtained by imaging an organ in a living body.

### CITATION LIST

### Patent Literature

PTL 1: JP 2008-093172 A

### Non-Patent Literature

NPL 1: T.-Y. Lin, P. Dollar, R. Girshick, K. He, B. Hariharan, and S. Belongie. Feature pyramid networks for object detection. In CVPR, 2017.

### SUMMARY

### Problem to be Solved

In training of an abnormality detection model related to abnormality detection, it is difficult to accurately train the abnormality detection model in a case where an abnormal region to be detected is similar to another region, a case where training data cannot be sufficiently obtained, or the like.

In view of the above-described problem, one object of the present disclosure is to provide a training device, a training method, and a storage medium capable of training an abnormality detection model that executes abnormality detection with high accuracy.

### Means for Solving the Problem

One mode of the training device is a training device including:
a feature amount acquisition means for acquiring
   a feature amount of an abnormal region of a training image that is an image used for training of an abnormality detection model and includes the abnormal region and
   a feature amount of an abnormality related region that is a region determined based on the abnormal region; and
a training means for training the abnormality detection model based on a degree of similarity between the feature amount of the abnormal region and the feature amount of the abnormality related region.

One mode of the training method is a training method including:
acquiring
   a feature amount of an abnormal region of a training image that is an image used for training of an abnormality detection model and includes the abnormal region and
   a feature amount of an abnormality related region that is a region determined based on the abnormal region; and
training the abnormality detection model based on a degree of similarity between the feature amount of the abnormal region and the feature amount of the abnormality related region.

One mode of the storage medium is a storage medium storing a program executed by a computer, the program causing the computer to execute processing including:
acquiring
   a feature amount of an abnormal region of a training image that is an image used for training of an abnormality detection model and includes the abnormal region and
   a feature amount of an abnormality related region that is a region determined based on the abnormal region; and
training the abnormality detection model based on a degree of similarity between the feature amount of the abnormal region and the feature amount of the abnormality related region.

### Effect

An example advantage according to the present invention is to train an abnormality detection model that executes abnormality detection with high accuracy.

### BRIEF DESCRIPTION OF THE DRAWINGS

FIG. 1 illustrates a schematic configuration of a training system.

FIG. 2 illustrates a hardware configuration of a training device.

FIG. 3 is a functional block diagram of the training device related to training of a lesion detection model.

FIG. 4 is a diagram schematically illustrating processing performed in a model execution unit.

FIG. 5 illustrates a training image clearly indicating a processing result by a feature amount acquisition unit in a case where a lesion peripheral region based on an anchor box is selected.

FIG. 6 is an example of a flowchart indicating an outline of processing executed by the training device in a first example embodiment.

FIGS. 7A and 7B FIG. 7A illustrates the training image clearly indicating a correspondence relationship between each block in a layer in which a most similar block exists and the training image. FIG. 7B illustrates the training image clearly indicating a correspondence relationship between each block in a layer in which an upper layer related block exists and the training image.

FIG. 8 is a block diagram of a training device in a second example embodiment.

FIG. 9 is an example of a flowchart executed by the training device in the second example embodiment.

### EXAMPLE EMBODIMENT

Hereinafter, example embodiments of a training device, a training method, and a storage medium will be described with reference to the drawings.

### First Example Embodiment

### (1) System Configuration

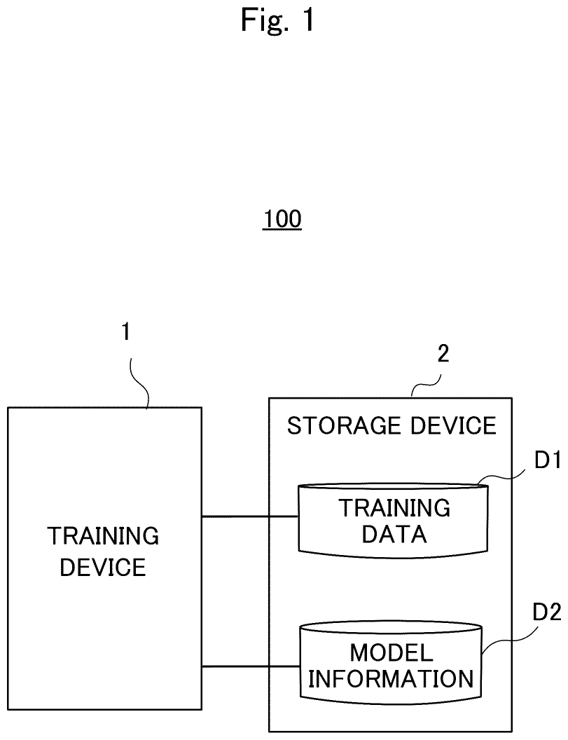

FIG. 1 illustrates a schematic configuration of a training system 100. As illustrated in FIG. 1, a training system 100 is a system that performs training of a model that detects an abnormality from an image obtained by imaging a subject to be an object for detecting an abnormality, and mainly includes a training device 1 and a storage device 2.

Hereinafter, as a representative example, training of a lesion detection model that detects an image region suspected of a lesion (also referred to as a “lesion region”) from an endoscopic image imaged in an examination using an endoscope by using a person as the subject will be described. Examples of the endoscope to be an object in the present disclosure include a laryngendoscope, a bronchoscope, an upper digestive tube endoscope, a duodenum endoscope, a small bowel endoscope, a large bowel endoscope, a capsule endoscope, a thoracoscope, a laparoscope, a cystoscope, a cholangioscope, an arthroscope, a spinal endoscope, a blood vessel endoscope, and an epidural endoscope. The model to be trained is not limited to the above-described lesion detection model, and may be a model that detects a lesion region from an optional medical image other than the endoscope, or may be a model that detects an abnormal region suspected of being abnormal from an image imaged in an appearance examination (appearance examination image) in which a subject is other than a person.

The training device 1 trains (performs learning of) the lesion detection model based on training data D1 stored in the storage device 2, and updates model information D2 stored in the storage device 2.

The storage device 2 is a memory that stores various types of information necessary for processing of the training device 1. The training data D1 and the model information D2 are included.

The training data D1 is training (training) data used for the training by the training device 1. The training data D1 includes a plurality of records, and each record includes a training image that is an image to be input to the lesion detection model in the training, and correct answer data indicating a correct answer to be output by the lesion detection model in a case where the training image is input to the lesion detection model. In the present example embodiment, as an example, it is assumed that the lesion detection model outputs an inference result including region information indicating a region detected in an image input to the lesion detection model and a class into which the region is classified, and the correct answer data indicates correct answer region information related to a lesion region in the training image and a correct answer class into which the lesion region is classified. Here, it is assumed that the “region information indicating a region” and the “correct answer region information related to a lesion region” indicate bounding boxes surrounding the regions. The “class into which the region is classified” and the “correct answer class into which the lesion region is classified” indicate classes (categories) into which the regions indicated by the paired region information are classified, and may indicate whether the region is the lesion region, or may indicate, in addition to whether the region is the lesion region, a type of a lesion in a case where the region is the lesion region.

The model information D2 is information related to the lesion detection model, and includes parameters updated by the training executed by the training device 1. Here, the lesion detection model is a model (engine) that outputs, in a case where an endoscopic image is input to the lesion detection model, an inference result related to a lesion region in the input image, in other words, a model that has learned a relationship between the input image (that is, the endoscopic image) and the lesion region in the image. The inference result output by the lesion detection model includes, for example, region information indicating a bounding box surrounding the detected region, a class indicating a classification result of the region in the bounding box, and a confidence score indicating the degree of confidence of the class classification.

The lesion detection model is, for example, a machine learning model (including a statistical model, the same applies hereinafter) having an optional architecture, such as a neural network or a support vector machine. As a representative example of a neural network used for the architecture of the lesion detection model, for example, a Feature Pyramid Network is used. Examples of the architecture included in the lesion detection model include, in addition to the Feature Pyramid Network, Featurized image pyramid, Fully Convolutional Network, SegNet, U-Net, V-Net, Mask R-CNN, DeepLab, AlexNet, VGG, ResNet, SqueezeNet, DenseNet, Inception, GoogLeNet, ShuffleNet, MobileNet, ResNeXt, Wide ReNet, and NASNet. In a case where the lesion detection model is configured by the neural network, the model information D2 includes, for example, various parameters (including hyperparameters) such as a layer structure, a neuron structure of each layer, the number of filters and a filter size in each layer, and a weight of each element of each filter.

Examples of a symptom to be detected by the lesion detection model include the following (a) to (f).
(a) Head and neck: pharyngeal cancer, malignant lymphoma, papilloma
(b) Esophagus: esophageal cancer, esophagitis, esophageal hiatal hernia, Barrett's esophagus, esophageal varices, esophageal achalasia, esophageal submucosal tumor, esophageal benign tumor
(c) Stomach: gastric cancer, gastritis, gastric ulcer, gastric polyp, gastric tumor
(d) Duodenum: duodenal cancer, duodenal ulcer, duodenitis, duodenal tumor, duodenal lymphoma
(e) Small bowel: small bowel cancer, small bowel neoplastic disease, small bowel inflammatory disease, small bowel vascular disease
(f) Large bowel: colorectal cancer, colorectal neoplastic disease, colorectal inflammatory disease, colorectal polyps, colorectal polyposis, Crohn's disease, colitis, intestinal tuberculosis, hemorrhoids

The storage device 2 may be an external storage device such as a hard disk connected to or incorporated in the training device 1, a storage medium such as a flash memory, a server device that performs data communication with the training device 1, or the like. The storage device 2 may include a plurality of storage devices, and may hold each of the above-described storage units in a distributed manner.

The configuration of the training system 100 illustrated in FIG. 1 is an example, and various changes may be made to the configuration. For example, the training device 1 and the storage device 2 may be achieved by the same device. In another example, the training device 1 may include a plurality of devices. In this case, the plurality of devices included in the training device 1 exchanges information necessary for executing pre-assigned processing between the devices by wired or wireless direct communication or by communication via a network.

### (2) Hardware Configuration

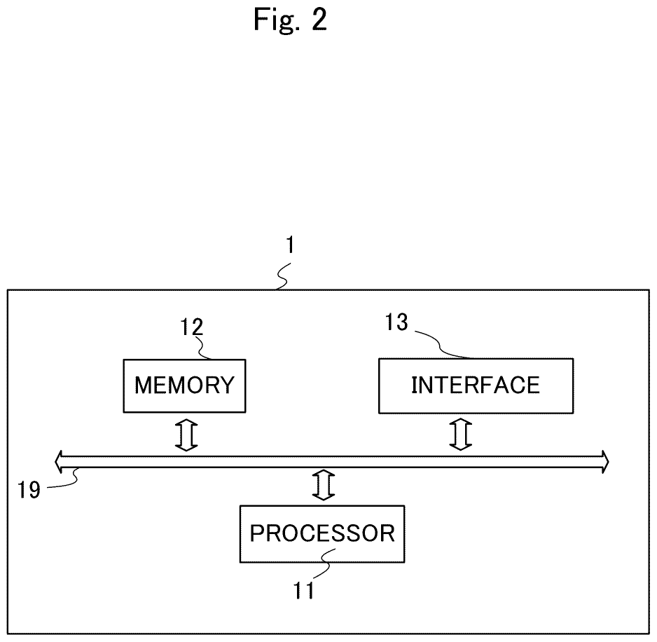

FIG. 2 illustrates an example of a hardware configuration of the training device 1. The training device 1 includes, as hardware, a processor 11, a memory 12, and an interface 13. The processor 11, the memory 12, and the interface 13 are connected to each other via a data bus 19.

The processor 11 functions as a controller (arithmetic device) that takes overall control of the training device 1 by executing a program stored in the memory 12. The processor 11 is, for example, a processor such as a central processing unit (CPU), a graphics processing unit (GPU), or a tensor processing unit (TPU). The processor 11 may include a plurality of processors. The processor 11 is an example of a computer.

The memory 12 includes various volatile memories and nonvolatile memories, such as a random access memory (RAM), a read only memory (ROM), and a flash memory. The memory 12 stores a program executed by the training device 1. A part of information stored in the memory 12 may be stored in an external storage device such as the storage device 2 capable of communicating with the training device 1, or may be stored in a storage medium attachable to and detachable from the training device 1. The memory 12 may store information stored in the storage device 2 instead.

The interface 13 is an interface for electrically connecting the training device 1 and another device. These interfaces may be a wireless interface such as a network adapter for wirelessly transmitting and receiving data to and from the another device, or may be a hardware interface for connecting to the another device by a cable or the like.

### (3) Outline of Training of Lesion Detection Model

Next, training of the lesion detection model will be described in detail. Schematically, in addition to a loss according to an error between correct answer data and an inference result output by the lesion detection model in a case where a training image is input to the lesion detection model, the training device 1 calculates a loss based on a degree of similarity between feature amounts of a lesion region specified by the correct answer data and a region existing around the lesion region. The training device 1 then updates the parameters of the lesion detection model in such a way as to optimize a loss obtained by integrating the above-described two losses. As a result, training of the lesion detection model capable of accurately detecting the lesion region having a similar feature to the peripheral region is performed.

Hereinafter, the loss according to the error between the correct answer data and the inference result output by the lesion detection model in a case where the training image is input to the lesion detection model is referred to as a “first loss L1”. The loss based on the similarity between the feature amounts of the lesion region specified by the correct answer data and the region existing around the lesion region (also referred to as a “lesion peripheral region”) is referred to as a “second loss L2”. The loss obtained by integrating the first loss L1 and the second loss L2 is referred to as an “integrated loss L”.

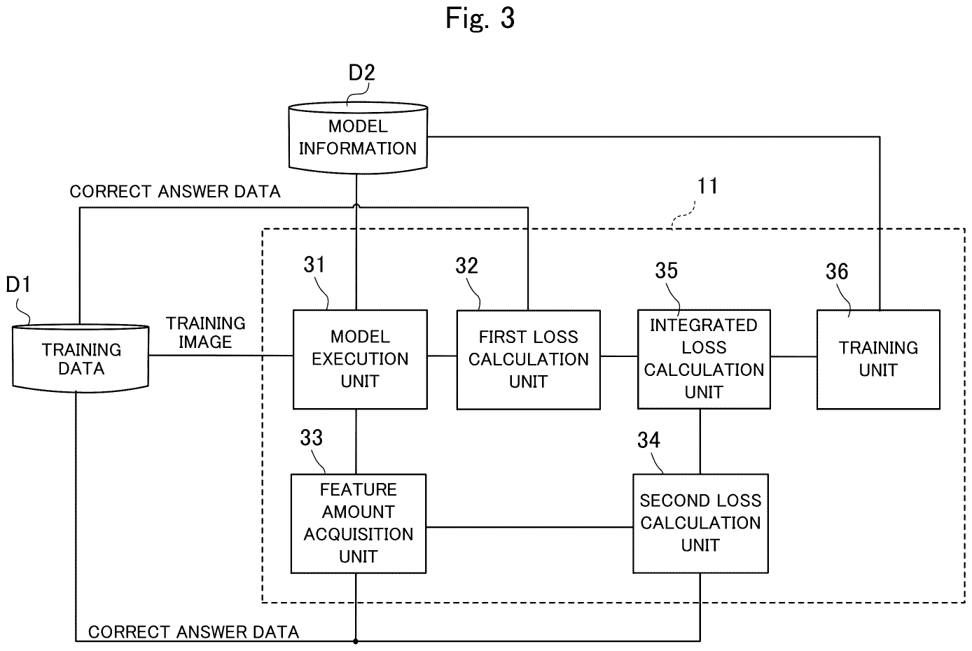

FIG. 3 is a functional block diagram of the training device 1 related to the training of the lesion detection model. The processor 11 of the training device 1 functionally includes a model execution unit 31, a first loss calculation unit 32, a feature amount acquisition unit 33, a second loss calculation unit 34, an integrated loss calculation unit 35, and a training unit 36. While blocks that exchange data with each other are connected by a solid line in FIG. 3, a combination of the blocks that exchange data with each other is not limited to that in FIG. 3. The same applies to diagrams of other functional blocks described later.

The model execution unit 31 acquires the inference result output by the lesion detection model by extracting the training image to be used for the training from the training data D1 and inputting the training image to the lesion detection model based on the model information D2. The model execution unit 31 supplies the acquired inference result to the first loss calculation unit 32. The model execution unit 31 also supplies intermediate data (for example, information related to the feature amounts and anchor boxes) generated in the lesion detection model before obtaining the inference result to the feature amount acquisition unit 33.

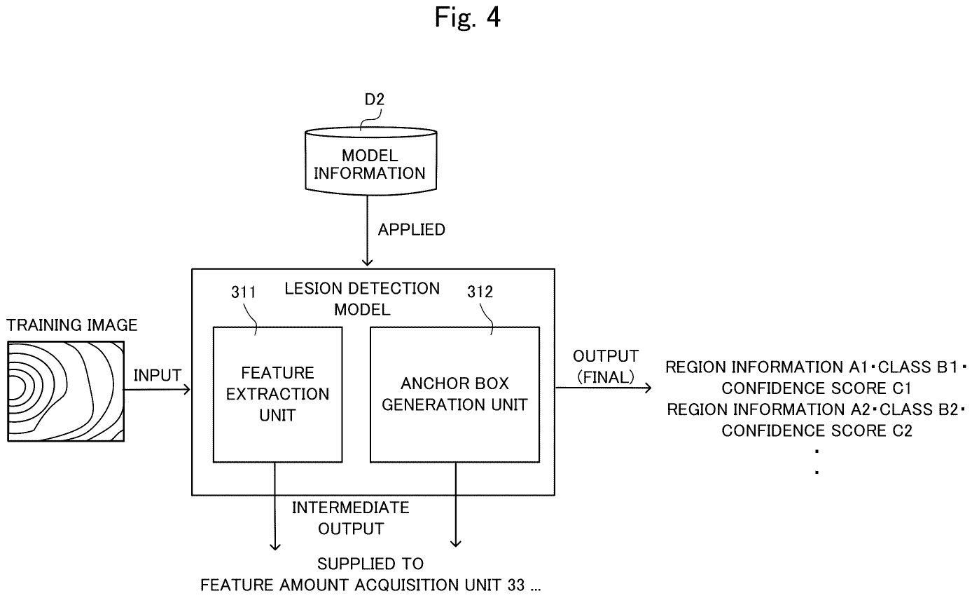

FIG. 4 is a diagram schematically illustrating processing performed in the model execution unit 31. The model execution unit 31 inputs the training image to the lesion detection model to which the parameters included in the model information D2 are applied. In this case, the lesion detection model outputs a set of region information indicating a bounding box surrounding a detected region, a class of the detected region, and a confidence score related to classification of the class. Here, the lesion detection model outputs the inference result including a set of region information A1, a class B1, and a confidence score C1 and a set of region information A2, a class B2, and a confidence score C2. The inference result is supplied to the first loss calculation unit 32 and used for calculation of the first loss L1.

The lesion detection model includes at least a feature extraction unit 311 and an anchor box generation unit 312.

The feature extraction unit 311 generates a feature amount of the training image input to the lesion detection model. For example, in a case where the lesion detection model has a network architecture based on the Feature Pyramid Networks, the feature extraction unit 311 generates a multiscale feature map (that is, having a plurality of layers having different granularities) by performing a convolution operation on the training image as the input image. The feature map is a map of feature amounts (feature vectors) and relates to a tensor obtained by convolution.

The anchor box generation unit 312 arranges anchor boxes of a plurality of sizes around each anchor point arranged on the feature map. The anchor boxes relate to prior distribution candidates of bounding box prediction. In this case, the anchor box generation unit 312 outputs information related to the anchor box (including a feature amount and a class probability related to the anchor box). As described later, in a case where the lesion peripheral region is determined in units of blocks of the feature map, existence of the anchor box generation unit 312 is not essential.

Processing results of the feature extraction unit 311 and the anchor box generation unit 312 are then supplied to the feature amount acquisition unit 33 as intermediate outputs.

Referring again to FIG. 3, the functional blocks of the training device 1 related to the training of the lesion detection model will be described.

The first loss calculation unit 32 acquires the correct answer data related to the training image input to the lesion detection model from the training data D1, and calculates the first loss L1 according to the error between the acquired correct answer data and the inference result output by the lesion detection model supplied from the model execution unit 31. In this case, the first loss L1 may be calculated based on an optional loss function such as a mean square error, a mean absolute error, a square root of a mean square error, a mean square log error, a Huber loss, a Poisson loss, a hinge loss, or a Kullback-Leibler divergence. The first loss calculation unit 32 supplies the calculated first loss L1 to the integrated loss calculation unit 35.

The feature amount acquisition unit 33 specifies the lesion region and the lesion peripheral region in the training image input to the lesion detection model based on the correct answer data, and acquires the feature amounts related to the specified lesion region and lesion peripheral region.

First, a method of specifying the lesion peripheral region will be described. For example, the feature amount acquisition unit 33 specifies the lesion peripheral region in units of blocks in which the feature amounts are determined in the feature map. In another example, the feature amount acquisition unit 33 selects an anchor box to be the lesion peripheral region from the anchor boxes generated by the anchor box generation unit 312. In these examples, the feature amount acquisition unit 33 determines, as the lesion peripheral region, the block or the anchor box that satisfies a predetermined determination condition for determining as the lesion peripheral region.

In a first example of the determination condition of the lesion peripheral region, the feature amount acquisition unit 33 determines, as the lesion peripheral region, the block or the anchor box whose distance to a bounding box of the lesion region based on the correct answer data is within a predetermined threshold. The above-described “distance” may be an Lp distance (including a Euclidean distance) on the image, or may be a value based on another optional distance function. Information related to the above-described “predetermined threshold” is stored in advance in the storage device 2 or the memory 12, for example. In this manner, the feature amount acquisition unit 33 determines the block or the anchor box to be the lesion peripheral region based on physical proximity to the lesion region.

In this case, preferably, the feature amount acquisition unit 33 specifies the block or the anchor box related to the lesion region, and then determines the lesion peripheral region from the blocks or the anchor boxes other than the block or the anchor box specified as the lesion region. In this case, the feature amount acquisition unit 33 determines, as the lesion region, a block or an anchor box determined to substantially match the bounding box of the lesion region indicated by the correct answer data. In this case, for example, the feature amount acquisition unit 33 determines, as the lesion region, a block or an anchor box in which an evaluation index of a degree of matching (also referred to as a “matching evaluation index”) of a region such as intersection over union (IoU) is equal to or more than a predetermined threshold. Hereinafter, for convenience of description, it is assumed that the larger a value of the matching evaluation index, the higher a degree of matching between two regions to be compared.

In a second example of the determination condition of the lesion peripheral region, the feature amount acquisition unit 33 determines, as the lesion peripheral region, a block or an anchor box in which the matching evaluation index such as the IoU with the lesion region (specifically, the bounding box of the lesion region) based on the correct answer data falls within a predetermined value range. The above-described “predetermined value range” is determined in such a way as to be a value range of the matching evaluation index that is determined to be unrelated to the lesion region and close to the lesion region, and the value range determined as such is stored in advance in the storage device 2, the memory 12, or the like.

Next, the acquisition of the feature amounts will be supplementarily described. The feature amount acquisition unit 33 acquires each of the feature amount related to the lesion region and the feature amount related to the lesion peripheral region from a feature extraction result output by the feature extraction unit 311. In a case where the lesion region and the lesion peripheral region are specified by the anchor boxes, the feature amount acquisition unit 33 may acquire the feature amounts associated with the anchor boxes from the anchor box generation unit 312. The feature amount acquisition unit 33 then supplies the feature amount of the lesion region and the feature amount of the lesion peripheral region to the second loss calculation unit 34.

The second loss calculation unit 34 calculates the second loss L2 based on the degree of similarity (also referred to as “similarity S”) between the feature amount of the lesion region and the feature amount of the lesion peripheral region. For the similarity S, an optional index serving as a measure of similarity between the feature amounts, such as a cosine distance, an inverse of the Lp distance, or an inverse of KL-divergence, may be used. In the following description, it is assumed that the similarity S has a higher value as the degree of similarity is higher. The second loss calculation unit 34 may calculate, instead of the similarity S, an index that has a lower value as the degree of similarity is higher.

In this case, the second loss calculation unit 34 calculates the second loss L2 from the similarity S based on a predetermined expression, lookup table, or the like that defines a relationship between the similarity S and the second loss L2 in such a way that the similarity S and the second loss L2 have a negative correlation. As a result, the second loss calculation unit 34 decreases the second loss L2 as the similarity S decreases. For example, the second loss calculation unit 34 calculates the second loss L2 by using the similarity S as a loss function as follows.

L2=S

In a case where the second loss calculation unit 34 calculates an index that has a lower value as the degree of similarity is higher instead of the similarity S, the second loss L2 is calculated by using, for example, a loss function that takes an inverse of the similarity S.

Here, calculation of the similarity S in a case where N (N is an integer of equal to or more than 2) lesion peripheral regions exist will be supplementarily described.

In this case, in a first calculation example of the similarity S, the second loss calculation unit 34 calculates similarity (that is, similarity for N) between the lesion region and the plurality of lesion peripheral regions, and uses a sum total of the similarity for N as the similarity S used for the calculation of the second loss L2. In a second calculation example, the second loss calculation unit 34 calculates similarity (that is, similarity for N) between the lesion region and the plurality of lesion peripheral regions, and uses a representative value (a mean value, a minimum value, a median value, or the like) of the similarity for N as the similarity S used for the calculation of the second loss L2. For example, in a case where a maximum value is used as the above-described representative value, similarity to the lesion peripheral region most similar to the lesion region is adopted as the similarity S.

The integrated loss calculation unit 35 calculates the integrated loss L obtained by integrating (summing) the first loss L1 calculated by the first loss calculation unit 32 and the second loss L2 calculated by the second loss calculation unit 34. In this case, the integrated loss calculation unit 35 calculates the integrated loss L from the first loss L1 and the second loss L2 based on an expression, a lookup table, or the like that defines a relationship between the first loss L1 and the second loss L2 and the integrated loss L in such a way that the first loss L1 and the second loss L2 have a positive correlation with the integrated loss L. In this case, in a case where the second loss L2 is fixed, the integrated loss L increases as the first loss L1 increases, and in a case where the first loss L1 is fixed, the integrated loss L increases as the second loss L2 increases.

For example, when it is assumed that a ratio of contribution of the second loss L2 to the integrated loss L is “α”, the integrated loss calculation unit 35 calculates the integrated loss L by the following expression.

L=(1−α)·L1+α·L2

The integrated loss calculation unit 35 may determine the integrated loss L from the first loss L1 and the second loss L2 based on an optional expression, lookup table, or the like that defines the relationship between the first loss L1 and the second loss L2 and the integrated loss L, not limited to the above expression.

The training unit 36 determines the parameters of the lesion detection model by gradient descent, backpropagation, or the like in such a way that the integrated loss L is optimized. More preferably, the training unit 36 determines the parameters of the lesion detection model in such a way that the integrated loss L is minimized. The training unit 36 then updates the model information D2 by reflecting the determined parameters of the lesion detection model in the model information D2. The training unit 36 updates the model information D2 for each record of the training data D1.

The components of the model execution unit 31, the first loss calculation unit 32, the feature amount acquisition unit 33, the second loss calculation unit 34, the integrated loss calculation unit 35, and the training unit 36 can be achieved by, for example, the processor 11 executing a program. Each component may also be achieved by recording a necessary program in an optional nonvolatile storage medium and installing the program as necessary. At least a part of these components is not limited to be achieved by software by a program, and may be achieved by a combination of any of hardware, firmware, and software, or the like. At least a part of these components may be achieved by using, for example, a user-programmable integrated circuit such as a field-programmable gate array (FPGA) or a microcontroller. In this case, a program including the above components may be achieved by using the integrated circuit. At least a part of the components may include an application specific standard produce (ASSP), an application specific integrated circuit (ASIC), or a quantum processor (quantum computer control chip). In this manner, the components may be achieved by various types of hardware. The same applies to another example embodiment described later. These components may also be achieved by, for example, cooperation of a plurality of computers by using a cloud computing technology or the like.

### (4) Selection of Lesion Peripheral Region

Next, a specific example of selection of the lesion peripheral region by the feature amount acquisition unit 33 will be described.

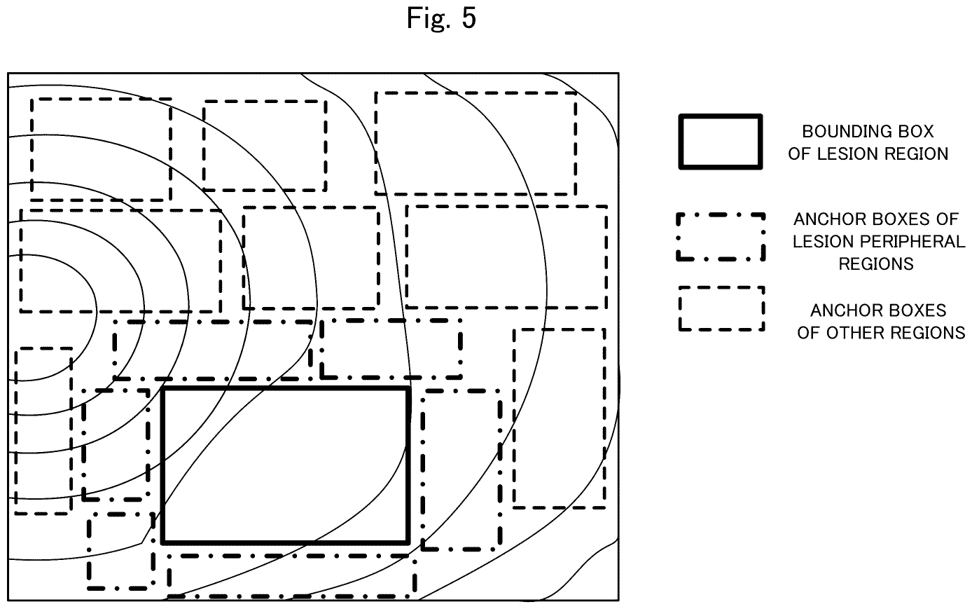

FIG. 5 illustrates the training image clearly indicating a processing result by the feature amount acquisition unit 33 in a case where the lesion peripheral region based on the anchor box is selected. In the training image illustrated in FIG. 5, the anchor boxes generated by the anchor box generation unit 312 and the bounding box of the lesion region based on the correct answer data are clearly indicated. Here, the bounding box of the lesion region based on the correct answer data is represented by a solid line, the anchor boxes specified as the lesion peripheral regions by the feature amount acquisition unit 33 are represented by alternate long and short dash lines, and the anchor boxes to be regions other than the lesion region and the lesion peripheral regions (also referred to as “other regions”) are represented by broken lines.

In the example of FIG. 5, the feature amount acquisition unit 33 recognizes the bounding box (may be the anchor box having the highest matching evaluation index) of the lesion region based on the correct answer data. The feature amount acquisition unit 33 specifies the anchor boxes around the bounding box of the lesion region as the lesion peripheral regions based on an index (a distance or the matching evaluation index) for measuring physical proximity to the bounding box of the lesion region. Although the anchor boxes do not overlap each other in FIG. 5, a large number of overlapping anchor boxes are actually generated.

In this manner, by specifying the lesion peripheral region physically close to the lesion region, and training the lesion detection model by using the second loss L2 based on the similarity S between the feature amount of the specified lesion peripheral region and the feature amount of the lesion region, the training device 1 promotes learning of features of a positive example.

The effect of selecting the lesion peripheral region will be further supplementarily described. In general, the number of anchor boxes classified as the lesion region (that is, the positive example) is overwhelmingly smaller than the number of anchor boxes classified as a non-lesion region (that is, a negative example) that is not the lesion region. In this case, contribution of the negative example (in particular, contribution of the negative examples related to the above “other regions” having a large difference in features from the lesion region) increases in the calculation of the first loss L1. Therefore, in a case where the parameters of the lesion detection model are learned in such a way as to optimize only the first loss L1, there arises a problem that the negative example is learned to be superior to the positive example and the learning of the feature of the positive example does not proceed. Some lesions, such as flat lesions (superficial lesions), are not characteristic in their global color or shape compared to their surroundings, and have a small number of learning samples due to a small prevalence and the small number of cases. In this case, there is a possibility that the lesion detection model in which learning of the features of the positive examples is not sufficient is generated.

In consideration of the above, in the present example embodiment, the training device 1 specifies, as the lesion peripheral region, the region in which the difference in the feature from the lesion region is particularly desired to be learned by the lesion detection model, and calculates the second loss L2 based on the similarity S between the feature amounts of the lesion region and the lesion peripheral region. The training device 1 then trains the lesion detection model in such a way as to optimize the integrated loss L obtained by integrating the first loss L1 and the second loss L2 by using the second loss L2 related to the feature of the positive example in addition to the first loss L1. As a result, the training device 1 can train the lesion detection model in such a way as to effectively balance the positive example and the negative example in one image.

### (5) Processing Flow

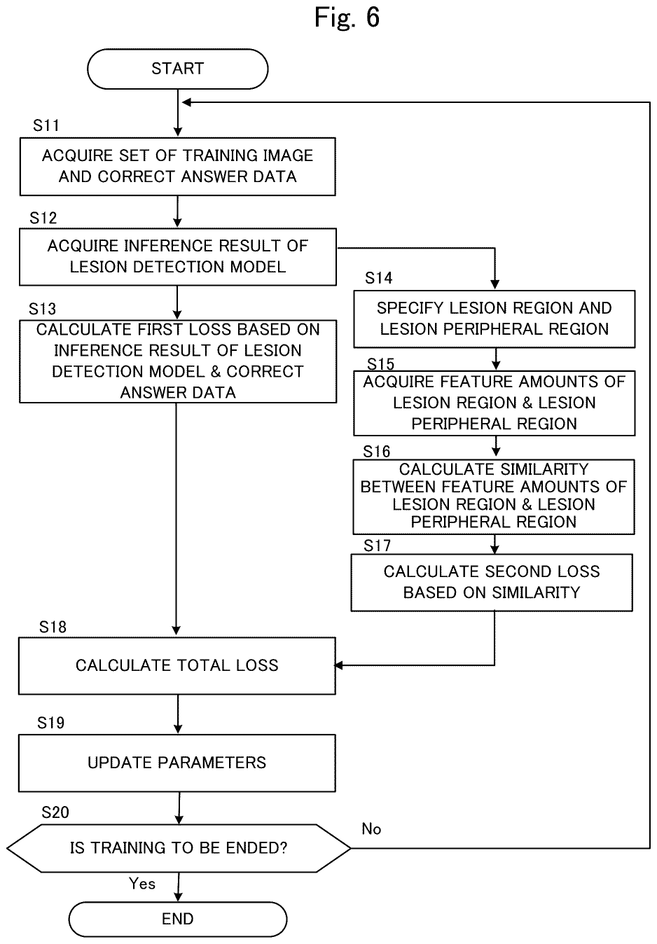

FIG. 6 is an example of a flowchart indicating an outline of the processing executed by the training device 1 in a first example embodiment.

First, the training device 1 acquires a set of correct answer data and a training image related to one record used for training of a lesion detection model from the training data D1 stored in the storage device 2 (step S11).

Next, the training device 1 acquires an inference result of the lesion detection model based on the model information D2 stored in the storage device 2 and the training image acquired in step S11 (step S12). In this case, the training device 1 acquires the inference result output by the lesion detection model by inputting the training image acquired in step S11 to the lesion detection model reflecting the model information D2. The training device 1 then calculates the first loss L1 based on the inference result of the lesion detection model and the correct answer data acquired in step S11 (step S13).

The training device 1 executes steps S14 to S17 before and after or in parallel with the processing of step S13. First, the training device 1 specifies a lesion region and a lesion peripheral region based on the correct answer data acquired in step S11 (step S14). The training device 1 then acquires a feature amount of the specified lesion region and a feature amount of the specified lesion peripheral region (step S15). The training device 1 then calculates the similarity S between the feature amount of the lesion region and the feature amount of the lesion peripheral region (step S16). The training device 1 then calculates the second loss L2 based on the similarity S calculated in step S16 (step S17).

After executing steps S13 to S17, the training device 1 calculates the integrated loss L based on the first loss L1 calculated in step S13 and the second loss L2 calculated in step S17 (step S18). The training device 1 then updates parameters of the lesion detection model stored in the model information D2 based on the integrated loss L calculated in step S18 (step S19). In this case, the training device 1 determines the updated parameters of the lesion detection model in such a way that the integrated loss L is optimized.

The training device 1 then determines whether the training is to be ended (step S20). For example, the training device 1 determines that the training is to be ended in a case where the lesion detection model is trained by using all records of the training data D1 or in a case where another predetermined training end condition is satisfied. In a case where it is determined that the training is to be ended (step S20; Yes), the training device 1 ends the processing of the flowchart. On the other hand, in a case where it is determined that the training is not to be ended (step S20; No), the training device 1 returns the processing to step S11. In this case, in step S11, the training device 1 extracts a record not used for the training of the lesion detection model from the training data D1.

### (6) Modifications

Next, modifications suitable for the above-described example embodiment will be described. The following modifications may be combined and applied to the above-described example embodiment.

### First Modification

In a case where a lesion detection model having an architecture that generates a multiscale feature map having a plurality of layers (for example, the Feature Pyramid Networks) is used, the training device 1 may calculate the similarity S based on feature amounts between layers in the feature map.

Hereinafter, as a premise, it is assumed that the multiscale feature map has a higher (coarser) granularity as the layer is higher. That is, it is assumed that a region in a training image expressed in one block becomes larger toward an upper layer. In this case, a feature of an upper layer is dominated by a feature of a wider area, and a feature of a lower layer is dominated by a feature of an inner side of a lesion.

The feature amount acquisition unit 33 first specifies a layer of the feature map having a block close to the bounding box of the lesion region (also referred to as a “most similar block”). In this case, for example, the feature amount acquisition unit 33 calculates the matching evaluation index (for example, the IoU) with the bounding box of the lesion region for each block of each layer, and determines a block having the highest matching evaluation index as the most similar block. In a case where the anchor box is determined in each layer, the feature amount acquisition unit 33 may perform the subsequent processing by using an anchor box having the highest matching evaluation index instead of the most similar block.

The feature amount acquisition unit 33 then specifies a block (also referred to as an “upper layer related block”) related to the most similar block in an upper layer, acquires a feature amount of the specified upper layer related block as the feature amount of the lesion peripheral region, and acquires a feature amount of the most similar block as the feature amount of the lesion region. The second loss calculation unit 34 then calculates the similarity S between the feature amount of the lesion peripheral region and the feature amount of the lesion region, and calculates the second loss L2 according to the similarity S.

Here, the upper layer related block may be a block related to the most similar block in one layer above the most similar block, or may be a block related to the most similar block in all or a predetermined number of layers above the most similar block.

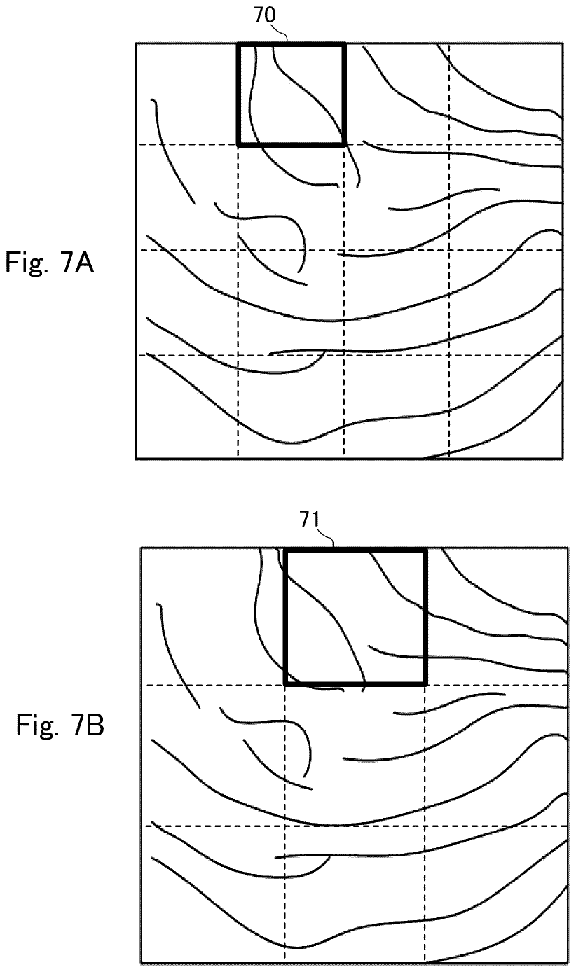

FIG. 7A illustrates the training image clearly indicating a correspondence relationship between each block in a layer in which the most similar block exists and the training image. FIG. 7B illustrates the training image clearly indicating a correspondence relationship between each block in the layer in which the upper layer related block exists and the training image.

In this case, the feature amount acquisition unit 33 determines a block 70 having the highest matching evaluation index with the bounding box of the lesion region as the most similar block, and determines a related block 71 in an upper layer of the layer in which the most similar block exists as the upper layer related block. The feature amount acquisition unit 33 then acquires a feature amount related to the block 70 as the feature amount of the lesion region, and acquires a feature amount related to the block 71 as the feature amount of the lesion peripheral region.

In addition to calculating similarity (also referred to as “upper layer similarity”) between the feature amount of the upper layer related block and the feature amount of the most similar block, the training device 1 may calculate similarity (also referred to as “lower layer similarity”) between the feature amount of the most similar block and a feature amount of a related block in a layer below the most similar block. In this case, for example, the training device 1 sets a sum of the upper layer similarity and the lower layer similarity as the similarity S, and calculates the second loss L2 based on the similarity S. Instead of setting the sum of the upper layer similarity and the lower layer similarity as the similarity S, the training device 1 may determine the similarity S in such a way as to have a positive correlation with the upper layer similarity and the lower layer similarity based on an optional expression or lookup table.

Also in the present modification, the training device 1 can suitably calculate the similarity S and the second loss L2, train the lesion detection model in consideration of the second loss L2, and promote learning of the feature of the positive example.

### Second Modification

The feature amount acquisition unit 33 may specify a related region (also referred to as a “lesion related region”) of the lesion region related to the lesion peripheral region based on color closeness instead of specifying the lesion peripheral region based on the physical proximity to the lesion region.

In this case, for example, the feature amount acquisition unit 33 specifies a block or an anchor box similar to the bounding box of the lesion region as the lesion related region by using, as a measure, an index value indicating a degree of one or a plurality of colors as a reference (also referred to as a “reference color index value”). Specifically, for example, the feature amount acquisition unit 33 specifies, as the lesion related region, a block or an anchor box that is other than the block or the anchor box specified as the lesion region and has the reference color index value within a predetermined difference from a reference color index value of the bounding box of the lesion region. The above predetermined difference is, for example, a predetermined value stored in advance in the storage device 2, the memory 12, or the like. The reference color index value may be any of RGB values included as pixel values in each pixel of the training image, or may be a value derived from the RGB values.

The second loss calculation unit 34 then calculates the similarity S based on the feature amount of the lesion region and a feature amount of the lesion related region, and calculates the second loss L2 based on the similarity S.

Also according to the present modification, the training device 1 can train the lesion detection model based on the second loss L2, and promote learning of the feature of the positive example.

### Third Modification

The model to be trained is not limited to the lesion detection model that outputs an inference result related to detection of a lesion region by using an endoscopic image as an input.

The model to be trained may be an optional abnormality detection model that outputs an inference result related to a region suspected of being abnormal (abnormal region) by using an image obtained by imaging a subject to be an object for detecting an abnormality as an input. For example, the abnormality detection model may be a model that outputs an inference result related to detection of an abnormal region by using an image imaged in an appearance examination (appearance examination image) as an input.

In this case, the feature amount acquisition unit 33 acquires a feature amount of the abnormal region based on the correct answer data instead of the feature amount of the lesion region, and acquires a feature amount of an abnormality related region having a physical distance or color feature close to that of the abnormal region instead of the feature amount of the lesion related region. The second loss calculation unit 34 then calculates the similarity S between the feature amount of the abnormal region and the feature amount of the abnormality related region, and sets the second loss L2 based on the similarity S.

In this manner, also in the training of the abnormality detection model other than the lesion detection model, the training device 1 can perform the training in consideration of the second loss L2 according to the similarity S, and promote learning of the feature of the positive example.

For example, a coping method may be determined based on a model generated by machine learning of a correspondence relationship between an abnormality detection result of a subject and the coping method, and an inference result related to abnormality detection of the subject output by the above abnormality detection model. The method of determining the coping method is not limited to the above-described method. It can be used to support decision making or the like of a user. The determination of the coping method and output of the information related to the coping method may be executed by the training device 1, or may be executed by an optional device other than the training device 1, which refers to model information of the trained abnormality detection model.

### Second Example Embodiment

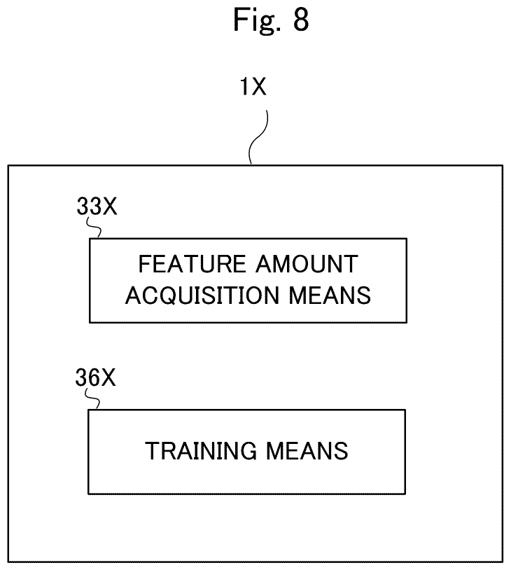

FIG. 8 is a block diagram of the training device 1X according to the second example embodiment. The training device 1X mainly includes a feature amount acquisition means 33X and a training means 36X. The training device 1X may be configured by plural devices.

The feature amount acquisition means 33X is configured to acquire a feature amount of an abnormal region of a training image that is an image used for training of an abnormality detection model and includes the abnormal region and a feature amount of an abnormality related region that is a region determined based on the abnormal region. Examples of the feature amount acquisition means 33X include the feature amount acquisition means 33 according to the first example embodiment (including modifications).

The training means 36X is configured to train the abnormality detection model based on a degree of similarity between the feature amount of the abnormal region and the feature amount of the abnormality related region.

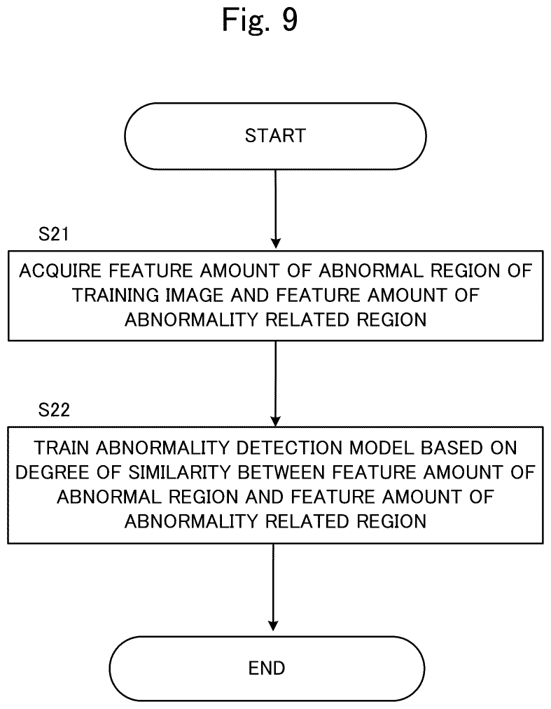

FIG. 9 illustrates a flowchart indicating the procedure of the process according to the second example embodiment. The feature amount acquisition means 33X acquires a feature amount of an abnormal region of a training image that is an image used for training of an abnormality detection model and includes the abnormal region and a feature amount of an abnormality related region that is a region determined based on the abnormal region (step S21). Next, the training means 36X trains the abnormality detection model based on a degree of similarity between the feature amount of the abnormal region and the feature amount of the abnormality related region (step S22).

The training device 1X according to the second example embodiment can train the abnormality detection model considering the similarity between the feature amount of the abnormal region and the feature amount of the abnormality related region.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above (including modifications, the same applies hereinafter) can be described as, but not limited to, the following Supplementary Notes.

### Supplementary Note 1

A training device comprising:
a feature amount acquisition means for acquiring
   a feature amount of an abnormal region of a training image that is an image used for training of an abnormality detection model and includes the abnormal region and
   a feature amount of an abnormality related region that is a region determined based on the abnormal region; and
a training means for training the abnormality detection model based on a degree of similarity between the feature amount of the abnormal region and the feature amount of the abnormality related region.

### Supplementary Note 2

The training device according to Supplementary Note 1, further comprising:
a first loss calculation means for calculating a first loss based on correct answer data related to the training image and an inference result output by the abnormality detection model in response to input of the training image to the abnormality detection model; and
a second loss calculation means for calculating a second loss based on the degree of similarity,
wherein the training means trains the abnormality detection model based on the first loss and the second loss.

### Supplementary Note 3

The training device according to Supplementary Note 2, wherein the second loss calculation means increases the second loss as the degree of similarity decreases.

### Supplementary Note 4

The training device according to Supplementary Note 2, wherein the training means determines parameters of the abnormality detection model to optimize an integrated loss obtained by integrating the first loss and the second loss.

### Supplementary Note 5

The training device according to Supplementary Note 1, wherein the feature amount acquisition means specifies, as the abnormality related region, a region of the training image existing around the abnormal region.

### Supplementary Note 6

The training device according to Supplementary Note 1, wherein
the abnormality detection model generates a map of feature amounts of a plurality of layers having different granularities, and
the feature amount acquisition means extracts, as the feature amount of the abnormality related region, a feature amount related to the abnormal region in a layer having a higher granularity than a granularity of a layer from which the feature amount of the abnormal region is extracted.

### Supplementary Note 7

The training device according to Supplementary Note 1, wherein the feature amount acquisition means specifies, as the abnormality related region, a region of the training image having a similar color to a color of the abnormal region.

### Supplementary Note 8

The training device according to Supplementary Note 1, wherein
the training image is a medical image, and
the abnormality detection model is a model that performs inference related to detection of a lesion region in the medical image.

### Supplementary Note 9

The training device according to Supplementary Note 1, wherein
the abnormality detection model is a machine learning model, and
the training means performs machine learning of the abnormality detection model.

### Supplementary Note 10

A training method by a computer, comprising:
acquiring
   a feature amount of an abnormal region of a training image that is an image used for training of an abnormality detection model and includes the abnormal region and
   a feature amount of an abnormality related region that is a region determined based on the abnormal region; and
training the abnormality detection model based on a degree of similarity between the feature amount of the abnormal region and the feature amount of the abnormality related region.

### Supplementary Note 11

A storage medium storing a program for causing a computer to execute processing comprising:
acquiring
   a feature amount of an abnormal region of a training image that is an image used for training of an abnormality detection model and includes the abnormal region and
   a feature amount of an abnormality related region that is a region determined based on the abnormal region; and
training the abnormality detection model based on a degree of similarity between the feature amount of the abnormal region and the feature amount of the abnormality related region.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1X Training device
2 Storage device
11 Processor
12 Memory
13 Interface
100 Training system
D1 Training data
D2 Model information

What is claimed is:

1. A training device comprising:
at least one memory configured to store instructions; and
at least one processor configured to execute the instructions to:
acquire
a feature amount of an abnormal region of a training image that is an image used for training of an abnormality detection model and includes the abnormal region and
a feature amount of an abnormality related region that is a region determined based on the abnormal region; and
train the abnormality detection model through machine learning based on a degree of similarity between the feature amount of the abnormal region and the feature amount of the abnormality related region.

2. The training device according to claim 1,
wherein the at least one processor is configured to execute the instructions to:
calculate a first loss based on correct answer data related to the training image and an inference result output by the abnormality detection model in response to input of the training image to the abnormality detection model;
calculate a second loss based on the degree of similarity; and
train the abnormality detection model based on the first loss and the second loss.

3. The training device according to claim 2, wherein the at least one processor is configured to execute the instructions to increase the second loss as the degree of similarity decreases.

4. The training device according to claim 2, wherein the at least one processor is configured to execute the instructions to determine parameters of the abnormality detection model to optimize an integrated loss obtained by integrating the first loss and the second loss.

5. The training device according to claim 1, wherein the at least one processor is configured to execute the instructions to specify, as the abnormality related region, a region of the training image existing around the abnormal region.

6. The training device according to claim 1, wherein
the abnormality detection model generates a map of feature amounts of a plurality of layers having different granularities, and
the at least one processor is configured to execute the instructions to extract, as the feature amount of the abnormality related region, a feature amount related to the abnormal region in a layer having a higher granularity than a granularity of a layer from which the feature amount of the abnormal region is extracted.

7. The training device according to claim 1, wherein the at least one processor is configured to execute the instructions to specify, as the abnormality related region, a region of the training image having a similar color to a color of the abnormal region.

8. The training device according to claim 1, wherein
the training image is a medical image, and
the abnormality detection model is a model that performs inference related to detection of a lesion region in the medical image.

9. The training device according to claim 1, wherein
the abnormality detection model is a machine learning model, and
the at least one processor is configured to execute the instructions to perform machine learning of the abnormality detection model.

10. A training method by a computer, comprising:
acquiring
a feature amount of an abnormal region of a training image that is an image used for training of an abnormality detection model and includes the abnormal region and
a feature amount of an abnormality related region that is a region determined based on the abnormal region; and
training the abnormality detection model based on a degree of similarity between the feature amount of the abnormal region and the feature amount of the abnormality related region.

11. A non-transitory computer readable storage medium storing a program for causing a computer to execute processing comprising:
acquiring
a feature amount of an abnormal region of a training image that is an image used for training of an abnormality detection model and includes the abnormal region and
a feature amount of an abnormality related region that is a region determined based on the abnormal region; and
training the abnormality detection model based on a degree of similarity between the feature amount of the abnormal region and the feature amount of the abnormality related region.
